(19) United States
(12) Patent Application Publication
(10) Pub. No.: US 2014/0218731 A1
(43) Pub. Date: Aug. 7, 2014

(54) CONFOCAL SPECTROMETER AND METHOD FOR IMAGING IN CONFOCAL SPECTROMETER

(71) Applicant: Anton Schick, Velden (DE)

(72) Inventor: Anton Schick, Velden (DE)

(73) Assignee: SIEMENS AKTIENGESELLSCHAFT, München (DE)

(21) Appl. No.: 14/348,514

(22) PCT Filed: Sep. 6, 2012
(86) PCT No.: PCT/EP2012/067421

§ 371 Date: Mar. 28, 2014

(30) Foreign Application Priority Data
Sep. 29, 2011 (DE) 102011083718.3

(51) Int. Cl. G01J 3/28; G01J 3/10; G01J 3/42

(52) U.S. Cl. CPC G01J 3/2823; G01J 3/42; G01J 3/10; G01J 2003/425
USPC 356/328; 356/326

(57) ABSTRACT

A broadband light source is provided for a confocal spectrometer having a first aperture device with a first slit grid of a main slit direction arranged in front of the light source to produce a slit-shaped pattern of the light source. A first imaging optical unit focuses the slit-shaped pattern of the light source on an object to be imaged. A detector system has a detector apparatus that captures the light reflected by the object for generating a spectrally resolved image of the object. A second imaging optical unit focuses the reflected light onto the detector apparatus. A dispersion element, arranged in front of the second imaging optical unit, spectrally disperses the light reflected by the object along a dispersion axis perpendicular to the optical axis of the second imaging optical unit.

### CROSS REFERENCE TO RELATED APPLICATIONS

This application is the U.S. national stage of International Application No. PCT/EP2012/067421, filed Sep. 6, 2012 and claims the benefit thereof. The International application claims the benefit of German Application No. 102011083718.3 filed on Sep. 29, 2011, both applications are incorporated by reference herein in their entirety.

### BACKGROUND

Described below are a confocal spectrometer and a method for imaging in a confocal spectrometer.

Confocal spectrometers operate on the basis of optical systems which have a common focus. In this way, a spatially pointwise measurement of scattered light can be carried out on an object to be imaged. Single-channel spectrometers to date generally use a linear camera in order to acquire the spectrum for one channel. It is therefore possible to acquire a spatially resolved image of the object only by scanning the object surface, that is to say by a time-based scan.

Multichannel spectrometers use a camera chip for linear sampling of a surface, spectral resolution taking place on the camera chip in a direction perpendicular to the spatial resolution. Such systems are also known as so-called hyperspectral imaging systems. In these systems as well, scanning of the object surface is necessary for imaging acquisition of the object.

Document EP 1 984 770 B1 discloses a confocal spectrometer system, encoding of a profile of an object being carried out by the spectral variation of a polychromatic light source. To this end, imaging optics with chromatic aberration are used in order to generate a wavelength-dependent position of the imaging focus along the optical axis.

Document DE 697 300 30 T2 discloses a confocal spectroscopic imaging system in which a modulator for imaging an illumination pattern onto an object to be imaged is used, so that spatial resolution of the object is possible by the illumination pattern sequence.

There is a need for an imaging spectrometer which, for a stationary object, delivers a spectrum of the reflected or scattered light for each image point in order to generate an image contrast.

### SUMMARY

One aspect is a confocal spectrometer having a broadband light source, a first aperture device arranged in front of the light source and having a first slit grid of a main slit direction, which is configured in order to generate a slit-shaped pattern of the light source, first imaging optics, which are configured in order to focus the slit-shaped pattern of the light source onto an object to be imaged, and a detector system, which has a detector apparatus, which is configured in order to acquire the light reflected by the object in order to generate a spectrally resolved image of the object, second imaging optics, which are configured in order to focus the reflected light onto the detector apparatus, and a dispersion element, which is arranged in front of the second imaging optics and is configured in order to spectrally disperse the light reflected by the object along a dispersion axis perpendicular to the optical axis of the second imaging optics.

One essential idea of the method is to permit full spatial resolution at the same time as full spectral resolution of the image of an object in a spectrometer. To this end, the confocal technique is used with an imaging aperture device, the aperture device having a slit pattern which projects a slit grid onto the entire object. When the projected slit grid reflected by the object is imaged confocally onto a detector apparatus, spectral resolution can be carried out in the intermediate spaces of the slit grid. This makes possible a spectrally dispersive element, which can image the reflected light with spectral resolution into the respective slit intermediate spaces.

According to one embodiment, the detector system may furthermore include a second aperture device having a second slit grid of the main slit direction of the first slit grid, which is arranged between the dispersion element and the detector apparatus and is configured in order to make a spectral selection of the reflected light striking the detector apparatus.

According to an embodiment, the second aperture device may be displaceable along the dispersion axis direction. This advantageously permits mechanical selection of a wavelength, to be imaged, of the reflected light.

According to another embodiment, the second slit grid may have a multiplicity of first slits, which are offset in relation to the slits of the first slit grid by a first predetermined distance perpendicularly to the main slit direction, and a multiplicity of second slits, which are offset in relation to the slits of the first slit grid by a second predetermined distance, different to the first distance, perpendicularly to the main slit direction. This offers the advantage that, for certain applications in which particular wavelengths of the reflected light are of interest, for example medical imaging methods in surgery or tissue diagnosis, a predefined selection of a number of wavelengths can be carried out without the second aperture device having to be mechanically displaced along the dispersion axis. In this way, complete spatially and spectrally resolved images of an object can be acquired confocally in a very short time.

According to another embodiment, the first aperture device may include a multiplicity of cylindrical lenses, which are configured in order to image light of the light source onto the slits of the first slit grid. This offers the advantage that the light intensity of the light source can be used maximally, since almost all of the light of the light source can be collimated onto the slit grid.

According to another embodiment, the spectrometer may furthermore include a beam splitter element, which is arranged in the beam path of the first imaging optics and is configured in order to deviate the reflected light of the object out of the beam path of the first imaging optics into the detector system. In this way, physical decoupling of the detector system from the imaging system is advantageously possible.

According to another embodiment, the dispersion element may include a prism, a diffraction grating, an interference filter or an acousto-optical modulator.

According to another embodiment, the detector apparatus may include a CCD sensor array, a CMOS sensor array or an avalanche photodiode array. In this case, the detector apparatus may be configured in order to spectrally resolve reflected image points of the object along an array axis. This is particularly advantageous, since individual image pixels of the object can respectively be imaged onto a subarray of pixels of the array of the detector apparatus. With the aid of this subarray of pixels, both spatially and spectrally resolved images of an object can be produced, which entails information enrichment in spatial representation of objects, particularly for medical imaging applications.

According to another embodiment, the light source may be a white light source. In this way, advantageously, at any time in the imaging each spectral component is equally available for acquisition in the reflected light spectrum. In particular, different wavelengths of the reflected light spectrum can thus be acquired simultaneously.

According to another aspect, described below is a method for imaging in a confocal spectrometer, by imaging a broadband light source onto a first aperture device having a first slit grid of a main slit direction for generating a slit pattern, focusing the slit pattern onto an object to be imaged, spectrally dispersing the light reflected by the object along a dispersion axis which is perpendicular to the main slit direction, focusing the spectrally dispersed reflected light onto a detector apparatus, and detecting the reflected light in the detector apparatus in order to generate a spectrally resolved image of the object.

According to one embodiment, the method may include focusing the spectrally dispersed reflected light onto a second aperture device having a second slit grid with the main slit direction of the first slit grid, which is arranged in front of the detector apparatus.

According to an embodiment, the method may include displacing the second aperture device along the dispersion axis direction in order to select the wavelength of the detected light. In this way, different wavelengths of the reflected light spectrum can be selected for acquisition in a controlled way during the spectroscopic acquisition.

### BRIEF DESCRIPTION OF THE DRAWINGS

These and other aspects and advantages will become more apparent and more readily appreciated from the following description of the exemplary embodiments and configurations with reference to the appended drawings, in which:

FIG. 1 is a schematic block diagram of a confocal spectrometer;

FIG. 2 is a schematic cross section of an aperture device of a confocal spectrometer;

FIG. 3 is a schematic representation of an image of a slit grid on a detector apparatus of a confocal spectrometer;

FIG. 4 is a schematic cross section of an aperture device of a confocal spectrometer;

FIG. 5 is a schematic representation of an image of a slit grid on a detector apparatus of a confocal spectrometer according to another aspect of the invention;

FIG. 6 is a schematic cross section of an aperture device of a confocal spectrometer;

FIG. 7 is a flow chart of a method for imaging in a confocal spectrometer;

FIG. 8 is a schematic block diagram of a confocal spectrometer;

FIG. 9 is a schematic front view of an aperture device of a confocal spectrometer;

FIG. 10 is a schematic block diagram of a confocal spectrometer; and

FIG. 11 is a flow chart of a method for imaging in a confocal spectrometer.

The described configurations and refinements may, where expedient, be combined with one another in any desired way. Further possible configurations, refinements and implementations also include not explicitly mentioned combinations of the features described above or below in relation to the exemplary embodiments.

The appended drawings are intended to impart further understanding of the embodiments. They illustrate embodiments and serve in connection with the description to explain principles and concepts. Other embodiments and many of the advantages mentioned are revealed with reference to the drawings. The elements of the drawings are not necessarily shown true to scale with respect to one another. References which are the same denote components which are the same or have a similar effect. The direction terminology used below with terms such as “up”, “down”, “right”, “left”, “front”, “rear”, etc. is used merely for easier understanding of the drawings, and represents no restriction of generality.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

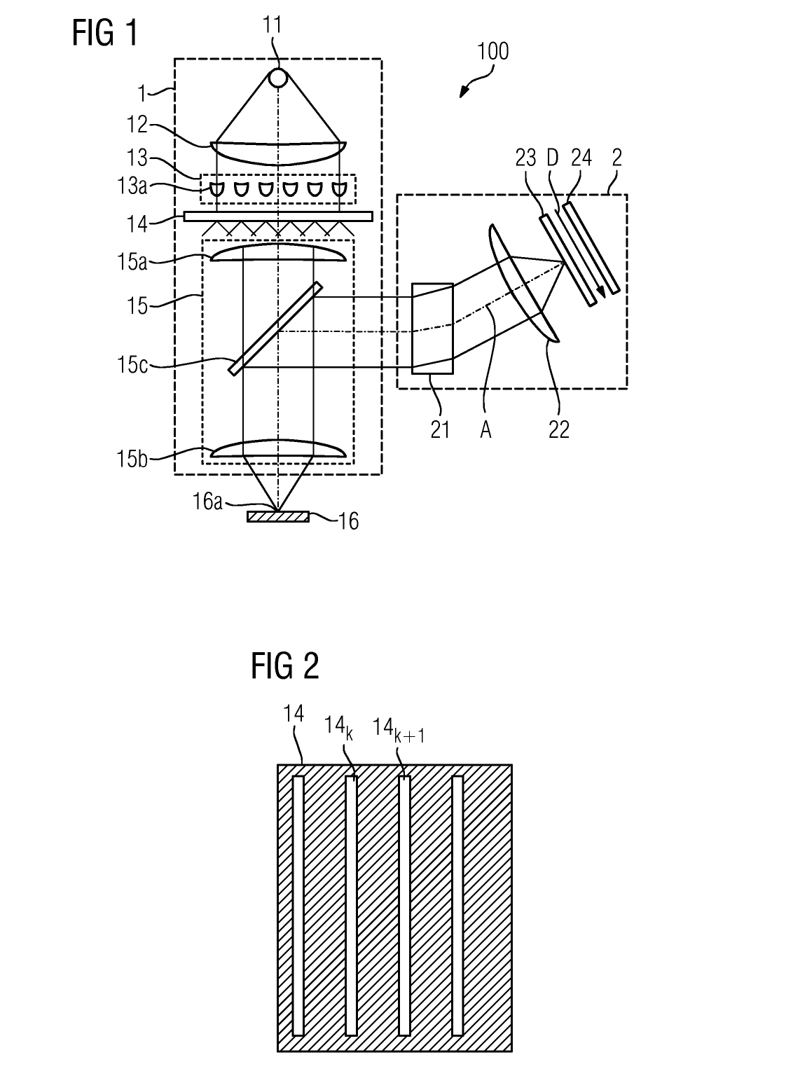

FIG. 1 shows a schematic representation of a confocal spectrometer 100. The spectrometer 100 has an imaging system 1, which is configured in order to focus the light of a light source 11 onto an object 16 to be spectroscopically analyzed. The spectrometer 100 furthermore includes a detector system 2, which is configured in order to acquire light that is scattered and/or reflected by the object 16, and to generate an image of the object 16 therefrom.

The imaging system 1 has a light source 11. The light source 11 may be a broadband or polychromatic light source 11, that is to say a light source 11 which emits light over a wide frequency or wavelength range. For example, the light source 11 may be a white light source, a Globar, a Nernst lamp, a nickel-chromium filament, a halogen gas discharge lamp, a xenon gas discharge lamp, a superluminescent diode, an LED or a similar polychromatic light source. Furthermore, the spectral wavelength range which the emission spectrum of the light source 11 covers may lie in the UV range, in the visible light range and/or in the infrared range.

The light emitted by the light source 11 may be collimated by a lens 12 to form a parallel ray bundle and directed onto a first aperture device 14. The first aperture device 14 may have a slit-shaped grid. An example of such a slit-shaped grid is represented schematically in FIG. 2. The first aperture device 14 in FIG. 2 has a structure of slits 14ₖ. The slits may be arranged in a slit-shaped pattern, so that two slits 14ₖ and 14ₖ₊₁ placed next to one another are separated by a predetermined lateral distance. The number of slits 14ₖ may be arbitrarily large. Likewise, the width of the slits 14ₖ may be arbitrarily large. The slits 14ₖ may have a length which may correspond to the length of the region to be resolved on the object 16.

In the imaging system 1, provision may be made for the collimated light to be focused by cylindrical lenses 13a in a cylindrical lenses arrangement 13 onto the slits of the slit grid 14ₖ of the first aperture device 14. In this case, one of the cylindrical lenses 13a may respectively be assigned to each slit 14ₖ. The cylindrical lenses arrangement 13 may, for example, be connected integrally to the first aperture device 14. By use of the cylindrical lenses 13, a larger fraction of the light of the light source 11 can be used for projection of the slit grid 14ₖ of the first aperture device 14 onto the object 16.

The light passing through the first aperture device 14 may be focused by first imaging optics 15 onto the object 16. In this case, the object 16 is illuminated on its surface at a focal point 16a by the light of the light source 11. The illumination is carried out in the pattern of the slit structure of the first aperture device 14. To this end, for example, tube optics 15a and an objective lens device 15b may be used.

The light scattered or reflected by the object 16 is guided back into the imaging optics 15 by the objective lens device 15b. A beam splitter element 15c, which may for example be a polarizing beam splitter, an interference filter or a similar optical element that splits an incident light beam, may be arranged in the imaging optics 15. The scattered or reflected light is deviated into the detector system 2 via a beam path having an optical axis.

The detector system 2 includes a spectrally dispersive element 21, which causes spectral splitting of the light, reflected in broadband fashion by the object, along a dispersion direction. The dispersion direction axis D may in this case be perpendicular to the optical axis A, so that the spectral information of the scattered or reflected light is resolved along the dispersion direction axis D. The dispersion element 21 may, for example, be a prism, a diffraction grating, a holographic grating, a blazed grating, an acousto-optical modulator, an interference filter or a similar element.

The spectrally dispersed light may be focused by a focusing lens 22 onto a second aperture device 23. The second aperture device 23 may, in particular, have a slit grid similar to the first aperture device 14. The spectrally dispersed light is imaged through the second aperture device 23 onto a detector apparatus 24.

It may in this case be possible to have a one-dimensional sensor array, for example a CCD sensor array, a CMOS sensor array, an avalanche photodiode array or a similar one-dimensional matrix of photosensitive sensor elements as the detector apparatus 24. The detector apparatus 24 may in this case be displaced together with the second aperture device 23 along the dispersion direction axis D, so that a fraction of the spectrally dispersed light of the dispersion element 21 can respectively be selected by the second aperture device 23 and imaged onto the detector apparatus 24.

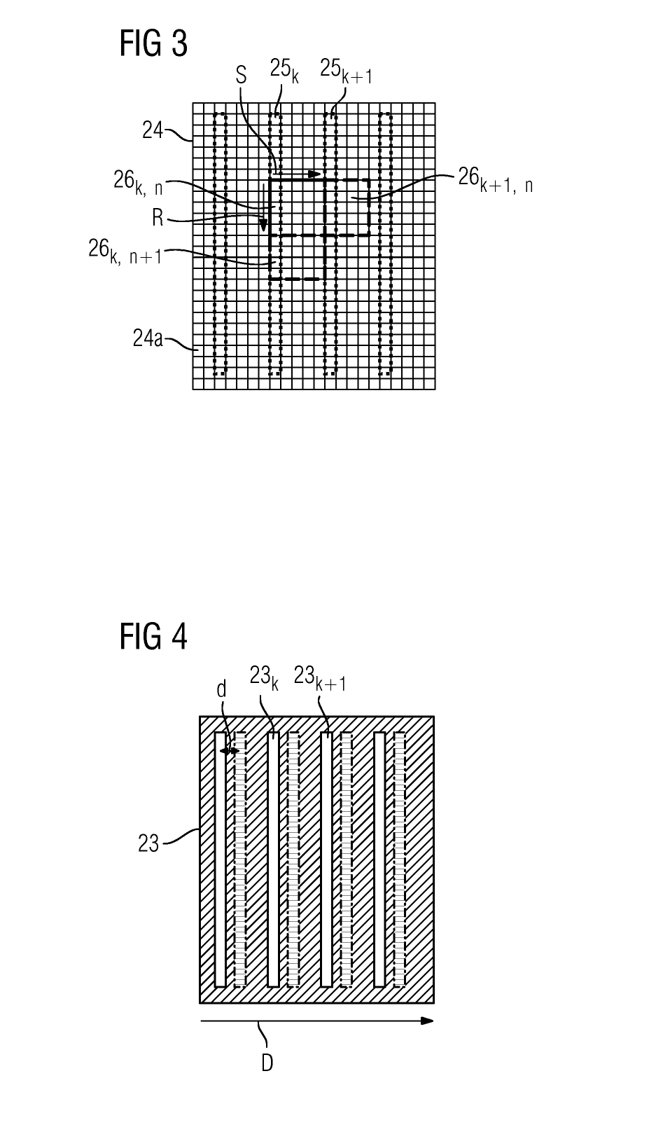

As an alternative, it may also be possible not to use a second aperture device 23. In this case, a two-dimensional sensor array, for example a CCD sensor array, a CMOS sensor array, an avalanche photodiode array or a similar two-dimensional matrix of photosensitive sensor elements may be used as the detector apparatus 24. In this way, each wavelength fraction of the spectrally dispersed light can be acquired along the array axis which extends parallel to the dispersion direction axis D. To this end, the spectrally dispersed light may be focused directly by the focusing lens 22 onto the detector apparatus 24. An exemplary embodiment of such a detector apparatus 24 is schematically represented for illustration in FIG. 3.

FIG. 3 shows a detector apparatus 24, which has an array 24a of detector pixels. The detector pixels may, for example, be individual sensor elements of the array 24a. The slit grid 14ₖ of the first aperture device 14 is in this case imaged confocally onto the detector array 24a. Then, for example, a beam pattern of slit images 25ₖ is formed. The slit images shown 25ₖ correspond respectively to a particular wavelength of the reflected and spectrally dispersed light. An image point of the object 16 is imaged into a subarray 26_{k,n} of the detector array 24a. In a main slit direction R, spatial resolution of the object 16 takes place in the vertical direction, while spectral resolution may take place along an array axis S.

Two neighbor pixels 26_{k+1,n} and 26_{k,n+1} of the subarray 26_{k,n} are shown in a dashed contour. The neighbor pixel 26_{k+1,n} in this case images an image point of the object 16 following on from the pixel 26_{k,n} in the lateral spatial direction, while the neighbor pixel 26_{k,n+1} images an image point of the object 16 following on from the pixel 26_{k,n} in the vertical spatial direction. Within each subarray, spectral resolution of the respective image point of the object 16 can take place along the array axis S, since the spectrally dispersive element 21 causes spectral splitting of the object image along the dispersion direction axis D, which may for example coincide with the array axis S. The selection of the spectral range, to be determined, of the reflected light may, for example, take place within the subarray 26_{k,n} by the electronic drive of the spectrally assigned pixels respectively lying along the array axis S.

When a second aperture device 23 is used, only that spectral part of the spectrally dispersed light which corresponds to the lateral offset of the second aperture device 23 along the dispersion direction axis D in relation to the position of the first aperture device 13 is deviated onto the detector apparatus 24. In other words, a spectral selection of the reflected light can be made by a lateral offset of the slit grid of the second aperture device 23, so that only a part of a two-dimensional detector apparatus 24 is illuminated.

FIG. 4 shows a schematic representation of a second aperture device 23. The second aperture device 23 may have a slit grid 23ₖ, which may correspond to the slit grid of the first aperture device 14. As a result of a lateral offset by a predetermined distance d along the dispersion direction axis D, the second aperture device 23 can select a particular spectrally split part of the reflected light. Through variation of the offset of the second aperture device 23 by different predetermined distances d, the entire spectrum of the scattered or reflected light can be imaged along the array axis S of a subarray 26_{k,n} of the detector array 24a.

FIG. 5 shows a schematic representation of an exemplary image of a spectral fraction of the image of the object 16. For example, an aperture device 23 laterally displaced by a predetermined distance d relative to the first aperture device 14 images a slit pattern 23ₖ onto the detector array 24a. This slit pattern 23ₖ is displaced along the array axis S relative to the slit pattern 25ₖ, and simultaneously images a different spectral range of the scattered or reflected light of the object onto the detector array 24a. In this way, spatial resolution of the object, that is to say imaging, and spectral resolution of the object may take place at the same time by the expansion of the image points of the object 16 into subarrays 26ₖ, of the detector apparatus 24.

The spectral image acquisition may, for example, be carried out by a scanning lateral offset movement of the aperture device 23. As an alternative, it may be possible to make a spectral selection by an electronic drive of the pixels of the detector apparatus 24.

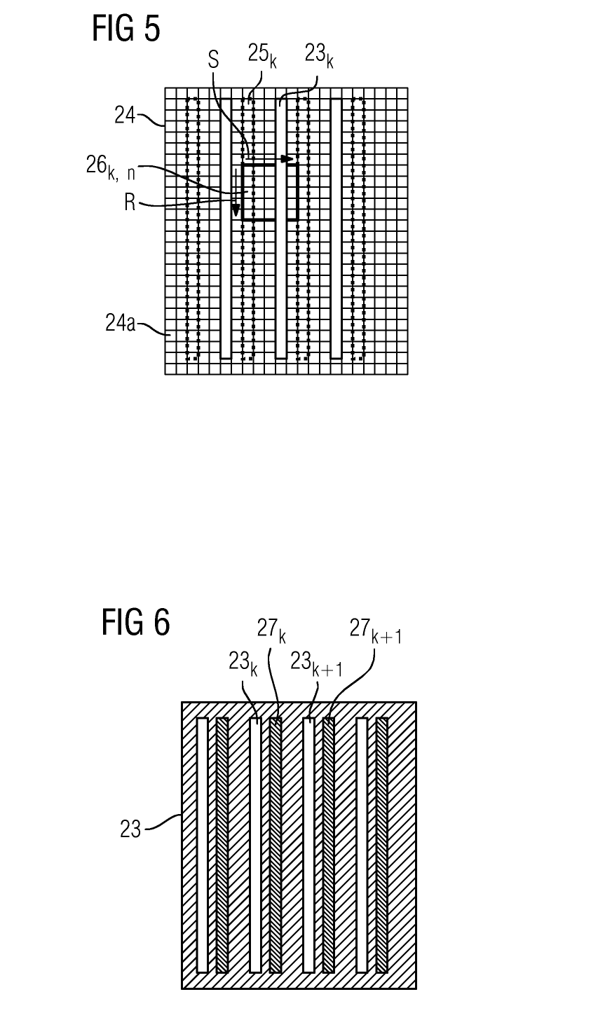

For certain applications, for example in the medical field, it may be expedient to make a preselection of spectral ranges to be resolved. FIG. 6 shows a schematic representation of a second aperture device 23, which, besides a first slit grid 23ₖ, also has a second slit grid 27ₖ which is offset relative to the first slit grid 23ₖ by a predetermined distance. The number of slit grids is represented as two in FIG. 6 merely by way of example—in principle, any desired number of slit grids may be used in order to select a multiplicity of wavelength ranges to be resolved. Owing to the preselection of the wavelength ranges, it is no longer necessary to move the second aperture device 23, since each slit grid 23ₖ and 27ₖ can project the spectrally dispersed wavelength range assigned to it onto separate pixel ranges of the detector array 24a. In this way, for example, one-dimensional detector arrays 24a with high photosensitivity, for example avalanche photodiode arrays, may be used, since in any event only a predetermined slit range of the detector apparatus 24 can be used for acquiring the light from the object 16. One conceivable application is to achieve spectral contrast between benign tissue and tumor tissue in imaging tissue diagnosis.

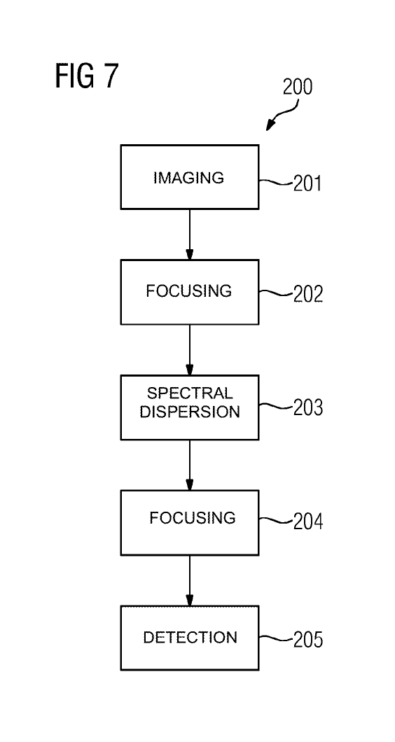

FIG. 7 shows a schematic representation of a method 200 for imaging in a confocal spectrometer, particularly in a confocal spectrometer 100 as shown in FIG. 1. The method 200 starts with imaging 201 of a broadband light source onto a first aperture device having a first slit grid of a main slit direction in order to generate a slit pattern. The light source may, for example, be a white light source or a polychromatic light source. The imaging of the light source may be carried out in such a way that the light source is imaged onto the slits of the first slit grid with the aid of a multiplicity of cylindrical lenses assigned to the slits.

Next is focusing 202 of the slit pattern onto an object to be imaged is carried out. Then, spectral dispersion 203 of the light reflected by the object takes place along a dispersion axis, which is perpendicular to the main slit direction. The spectral dispersion may for example be carried out with the aid of a prism, a diffraction grating, an interference filter or an acousto-optical modulator.

Fourth is focusing 204 of the spectrally dispersed reflected light onto a detector apparatus may be carried out. In this case, it may be possible to focus the spectrally dispersed light onto a second aperture device having a second slit grid with the main slit direction of the first slit grid. It is in this case possible for a part of the light reflected by the object to be deviated with a beam splitter element out of the beam path of the imaging of the slit pattern.

Finally, detection 205 of the reflected light is carried out in order to generate a spectrally resolved image of the object. The detection of the reflected light may for example be carried out with a two-dimensional CCD sensor array, a CMOS sensor array or an avalanche photodiode array. In this case, the reflected image points of the object may be spectrally resolved along an array axis. When a second aperture device is used, in order to select the wavelength of the detected light it may be possible to displace the second aperture device along the dispersion axis direction in order to select the wavelength of the detected light. In this case, a one-dimensional sensor array may also be used as the detector apparatus, for example a sensitive one-dimensional avalanche photodiode array which can be displaced together with the second aperture device along the dispersion axis direction.

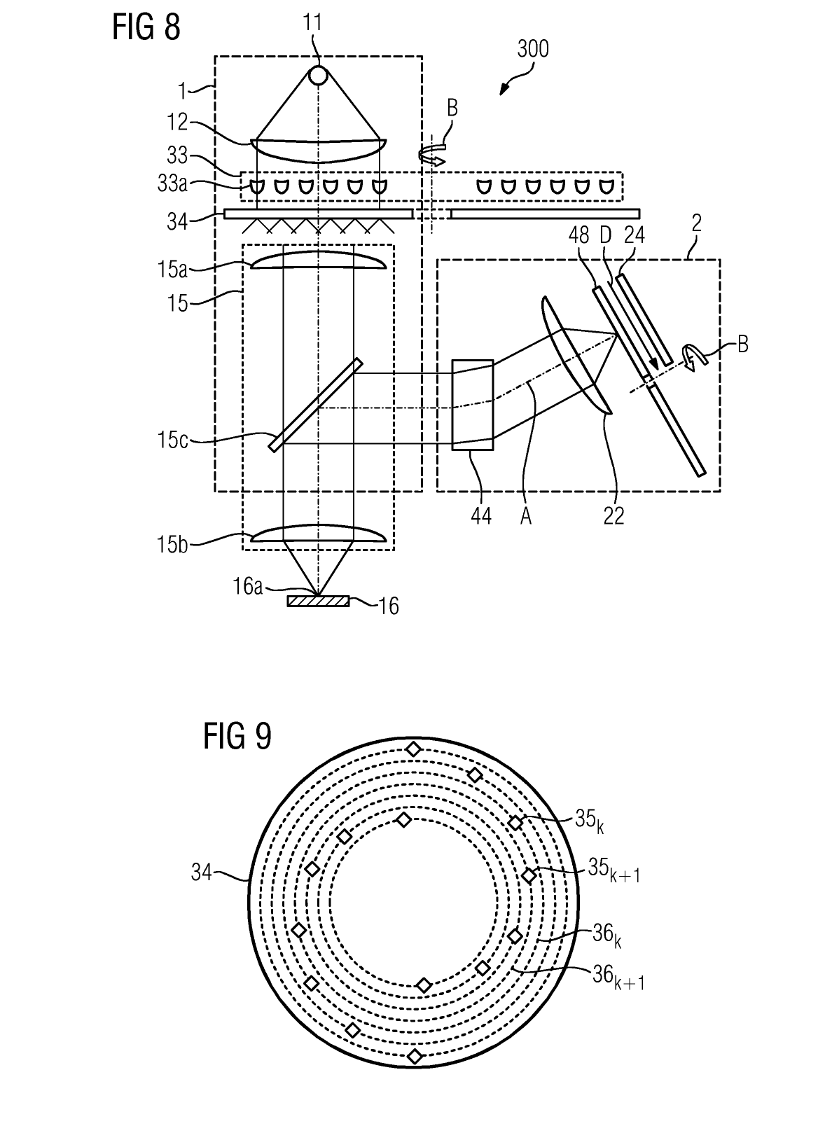

FIG. 8 shows a schematic representation of a confocal spectrometer 300. The spectrometer 300 has an imaging system 1, which is configured in order to focus light of a light source 11 onto an object 16 to be spectroscopically analyzed. The spectrometer 300 furthermore includes a detector system 2, which is configured in order to acquire light that is scattered and/or reflected by the object 16, and to generate an image of the object 16 therefrom.

The imaging system 1 has a light source 11. The light source 11 may be a broadband or polychromatic light source 11, that is to say a light source 11 which emits light over a wide frequency or wavelength range. For example, the light source 11 may be a white light source, a Globar, a Nernst lamp, a nickel-chromium filament, a halogen gas discharge lamp, a xenon gas discharge lamp, a superluminescent diode, an LED or a similar polychromatic light source. Furthermore, the spectral wavelength range which the emission spectrum of the light source 11 covers may lie in the UV range, in the visible light range and/or in the infrared range.

The light emitted by the light source 11 may be collimated by a lens 12 to form a parallel ray bundle and directed onto a first aperture device 34. The first aperture device 34 may have a structured arrangement of a multiplicity of holes, so-called pinholes. One example of such a structured arrangement may be a Nipkow disk, as is represented by way of example in FIG. 9.

The first aperture device 34 in FIG. 9 is circular and has a structure of holes 35ₖ. The holes 35ₖ may be arranged along concentric circular paths 36ₖ of different diameter, so that two holes 35ₖ and 35₄₁ placed next to one another along the circumference of the first aperture device 34 are separated by a predetermined distance. The number of holes 35ₖ may be arbitrarily large. By rapid rotation of the first aperture device 34, the entire object 16 can be temporally scanned over the entire aperture device 34, since, owing to the staggered arrangement of the paths 36ₖ, each image point of the object 16 is passed over once by at least one hole 35ₖ during a full rotation of the aperture device 34. An aperture device 34 may also be referred to as a Nipkow disk.

In the imaging system 1, provision may be made for the collimated light to be focused by lenses 33a in a lens arrangement 33 onto the holes of the first aperture device 34. In this case, one of the lenses 33a may respectively be assigned to each hole 34ₖ. The lens arrangement 33 may, for example, be connected integrally to the first aperture device 34. By virtue of the lenses 33, a higher fraction of the light of the light source 11 can be used for projection of the structure of holes 34ₖ of the first aperture device 34 onto the object 16.

The light passing through the first aperture device 34 may be focused by first imaging optics 15 onto the object 16. In this case, the object 16 is illuminated on its surface at a focal point 16a by the light of the light source 11. The illumination is carried out by rotation of the first aperture device 34 over the entire field of view of the object 16. To this end, for example, tube optics 15a and an objective lens device 15b may be used.

The light scattered or reflected by the object 16 is guided back into the imaging optics 15 by the objective lens device 15b. A beam splitter element 15c, which may for example be a polarizing beam splitter, an interference filter or a similar optical element that splits an incident light beam, may be arranged in the imaging optics 15. The scattered or reflected light is deviated into the detector system 2 via a beam path having an optical axis A.

The detector system 2 includes a spectrally dispersive element 41, which causes spectral splitting of the light, reflected in broadband fashion by the object, along a dispersion direction. The dispersion direction axis D may in this case be perpendicular to the optical axis A, so that the spectral information of the scattered or reflected light is resolved along the dispersion direction axis D. The dispersion element 41 may, for example, be a prism, a diffraction grating, a holographic grating, a blazed grating, an acousto-optical modulator, an interference filter or a similar element.

The spectrally dispersed light may be focused by a focusing lens 22 onto a second aperture device 43. The second aperture device 43 may, in particular, have a hole 35ₖ pattern similar to the first aperture device 34. The spectrally dispersed light is imaged through the second aperture device 43 onto a detector apparatus 24. The detector apparatus 24 may for example include a two-dimensional CCD sensor array, a CMOS sensor array, an avalanche photodiode array or a similar matrix of photosensitive sensor elements.

The second aperture device 43 can in this case rotate about an axis B, so that the rotation of the holes coincides with that of the holes 35ₖ of the first aperture device 34. In this way, light reflected or scattered by the object 16 can be imaged confocally with the first aperture device 43. This means that depth selection can be carried out, since only image points on the object 16 which lie within the focal depth of the focal point 16 can be imaged through the second aperture device 43.

By the spectral dispersion of the dispersion element 41 along the dispersion axis D, a lateral offset of the second aperture device 43 along this dispersion direction axis D can be carried out for spectral selection of the confocally acquired light of the object 16. In other words, at the same time as full lateral resolution of the object 16, spectral resolution of the object 16 is possible at the same time by adjusting a lateral offset between the first aperture device 34 and the second aperture device 43 with respect to the optical axis A.

As an alternative, it is also possible to achieve a displacement of the spectrum with respect to the optical axis by manipulation of the dispersion element 41. For example, a prism 41 may be rotated or an acousto-optical modulator 41 may be driven accordingly.

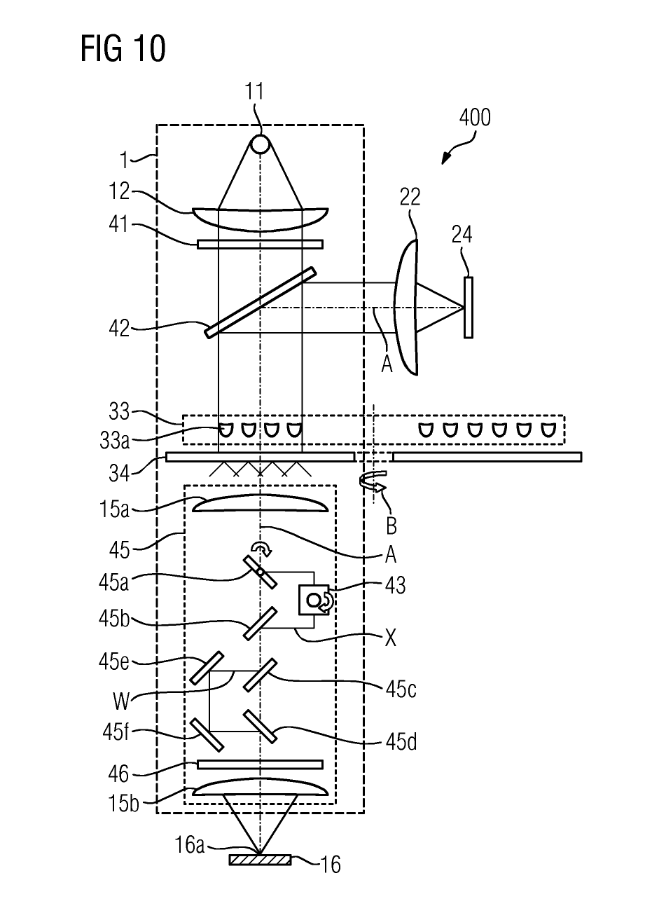

FIG. 10 shows a further confocal spectrometer 400 in a schematic representation. The spectrometer 400 in FIG. 10 differs from the spectrometer 300 in FIG. 8 essentially in that the first aperture device 34 is used as a common illumination and imaging device. To this end, imaging optics 45, in which different beam paths of the incident and reflected light can be produced by beam splitter elements 45a, 45b, 45c, 45d and mirror elements 45e and 45f, are provided after the first aperture device 34.

To this end, a polarizer 41, which linearly polarizes the light emerging from the light source 11, may be provided behind the lens 12. The incident light passes through the beam splitters 45a and 45b in a straight line when the latter are polarization-dependent beam splitters, for example s-polarizing beam splitters. Due to the p-polarizing beam splitters 45c and 45d and the mirror elements 45e and 45f, the incident light is guided along the beam path W to the object. With the aid of a lambda/4 plate 46, phase rotation of the polarization through 90° can be carried out.

The light reflected or scattered by the object is phase-shifted again through 90° by the lambda/4 plate 46, so that the reflected light can pass unimpeded in a straight line through the p-polarizing beam splitters 45d and 45c, and is deviated along the beam path X at the beam splitter 45b. The optical path lengths over the beam paths W and X may in this case be the same. In the beam path X, there is a spectrally dispersive element 43, for example a prism, which causes spectral splitting of the reflected or scattered light of the object. By rotation of the beam splitter 45a, it is possible to carry out spectral selection of the reflected or scattered light which is guided via the aperture device 34 onto a beam splitter 42 and deviated from there through a focusing lens 22 onto the detector apparatus 24. As an alternative, it may be possible to achieve wavelength selection for imaging onto the detector apparatus 24 by rotation of the spectrally dispersive element 41.

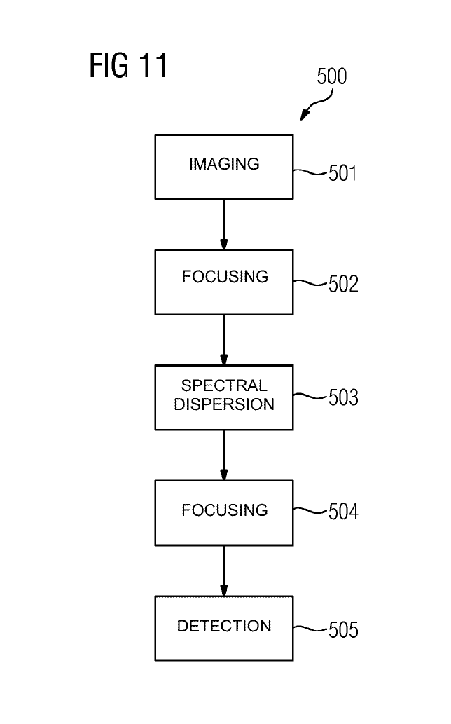

FIG. 11 shows a schematic representation of a method 500 for imaging in a confocal spectrometer, particularly in a confocal spectrometer 300 or 400 as explained in connection with FIGS. 8 to 10.

First, imaging 501 of a broadband light source takes place through a rotatable aperture device having a structured arrangement of a multiplicity of holes. The light source may in this case be a white light source or a polychromatic light source. The rotatable aperture device may, for example, include a Nipkow disk. Then, focusing 502 of the image of the structured arrangement of the multiplicity of holes onto an object to be imaged takes place. In this case, the imaging of the light source may be imaging of the light source on the structured arrangement of the multiplicity of holes with the aid of a multiplicity of lenses assigned to the holes.

Next, spectral dispersion 503 of the light reflected by the object is carried out with the aid of a dispersion element, for example a prism, a diffraction grating, an interference filter, or an acousto-optical modulator. Fourth, focusing 504 of the spectrally dispersed reflected light onto a rotatable aperture device having a structured arrangement of a multiplicity of holes is carried out. In this case, the rotatable aperture device may be displaced perpendicularly to the optical axis of the spectrometer for selection of the wavelength of the detected light. As an alternative, the dispersion element may be displaced perpendicularly to the optical axis of the spectrometer for selection of the wavelength of the detected light.

Finally, detection 505 of the reflected light passing through the rotatable aperture device is carried out in order to generate a spectrally resolved image of the object. The detection of the reflected light may be carried out with the aid of a CCD sensor array, a CMOS sensor array or an avalanche photodiode array, so that the reflected image points of the object can be spectrally resolved along an array axis.

Although principles, technical effects and features have only been presented and explained with reference to some of the figures, it is however readily possible to apply configuration variants and modifications of an embodiment explained in one of the figures to any other of the embodiments of the other figures.

Described above is a confocal spectrometer having a broadband light source, a first aperture device arranged in front of the light source and having a first slit grid of a main slit direction, which is configured in order to generate a slit-shaped pattern of the light source, first imaging optics, which are configured in order to focus the slit-shaped pattern of the light source onto an object to be imaged and a detector system, which includes a detector apparatus, which is configured in order to acquire the light reflected by the object in order to generate a spectrally resolved image of the object, second imaging optics, which are configured in order to focus the reflected light onto the detector apparatus, and a dispersion element, which is arranged in front of the second imaging optics and is configured in order to spectrally disperse the light reflected by the object along a dispersion axis perpendicular to the optical axis of the second imaging optics.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-15. (canceled)

16. A confocal spectrometer, comprising:
a broadband light source;
a first aperture device arranged in front of the light source and having a first slit grid of a main slit direction, configured to generate a slit-shaped pattern of the light source;
first imaging optics, configured to focus the slit-shaped pattern of the light source onto an object to be imaged; and
a detector system, including
a detector apparatus, configured to acquire the light reflected by the object and to generate a spectrally resolved image of the object;
second imaging optics, configured to focus the reflected light onto the detector apparatus; and
a dispersion element, arranged in front of the second imaging optics and configured to spectrally disperse the light reflected by the object along a dispersion axis perpendicular to the optical axis of the second imaging optics.

17. The spectrometer as claimed in claim 16, wherein the detector system further includes a second aperture device having a second slit grid of the main slit direction of the first slit grid, arranged between the dispersion element and the detector apparatus and configured to make a spectral selection of the reflected light striking the detector apparatus.

18. The spectrometer as claimed in claim 17, wherein the second aperture device can be displaced along the dispersion axis direction to select the wavelength of the reflected light striking the detector apparatus.

19. The spectrometer as claimed in claim 18, wherein the second slit grid comprises
a multiplicity of first slits, offset in relation to the slits of the first slit grid by a first predetermined distance perpendicularly to the main slit direction, and
a multiplicity of second slits, offset in relation to the slits of the first slit grid by a second predetermined distance, different from the first distance, perpendicularly to the main slit direction.

20. The spectrometer as claimed in claim 19, wherein the first aperture device has a multiplicity of cylindrical lenses, configured to image light of the light source onto the slits of the first slit grid.

21. The spectrometer as claimed in claim 20, further comprising a beam splitter element, arranged in the beam path of the first imaging optics and configured to deviate the reflected light of the object out of the beam path of the first imaging optics into the detector system.

22. The spectrometer as claimed in claim 21, wherein the dispersion element comprises at least one of a prism, a diffraction grating, an interference filter and an acousto-optical modulator.

23. The spectrometer as claimed in claim 22, wherein the detector apparatus comprises at least one of a CCD sensor array, a CMOS sensor array and an avalanche photodiode array, and is configured to spectrally resolve reflected image points of the object along an array axis.

24. The spectrometer as claimed in claim 22, wherein the light source is a white light source.

25. A method for imaging in a confocal spectrometer, comprising:
imaging a broadband light source onto a first aperture device having a first slit grid of a main slit direction for generating a slit pattern;
focusing the slit pattern onto an object to be imaged;
spectrally dispersing the light reflected by the object along a dispersion axis perpendicular to the main slit direction;
focusing the spectrally dispersed reflected light onto a detector apparatus; and
detecting the reflected light in the detector apparatus to generate a spectrally resolved image of the object.

26. The method as claimed in claim 25, further comprising focusing the spectrally dispersed reflected light onto a second aperture device having a second slit grid of the main slit direction of the first slit grid, arranged in front of the detector apparatus.

27. The method as claimed in claim 26, further comprising displacing the second aperture device along the dispersion axis direction to select the wavelength of the detected light.

28. The method as claimed claim 27, further comprising splitting the light reflected by the object with a beam splitter element out of the beam path of the imaging of the slit pattern.

29. The method as claimed claim 28,
wherein said detecting of the reflected light is carried out using at least one of a CCD sensor array, a CMOS sensor array and an avalanche photodiode array, and
wherein reflected image points of the object are spectrally resolved along an array axis.

30. The method as claimed claim 29, wherein said imaging of the light source comprises imaging of the light source onto the slits of the first slit grid with the aid of a multiplicity of cylindrical lenses assigned to the slits.
